(19) United States
(12) Patent Application Publication
(10) Pub. No.: US 2009/0112736 A1
(43) Pub. Date: Apr. 30, 2009

(54) METHOD OF MARKING AND SEARCHING DESIGNATED HOME SITES ON THE INTERNET

(76) Inventor: Charles CHEHEBAR, New York, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/129,884

(22) Filed: May 30, 2008

Related U.S. Application Data
(60) Provisional application No. 61/001,233, filed on Oct. 31, 2007.

(51) Int. Cl. G06Q 30/00; G06F 17/30

(52) U.S. Cl. 705/27; 707/3; 707/E17.014; 707/E17.032

(57) ABSTRACT

An Internet based system for distributing items from a source, such as goods, services or information, includes several websites associated with vendors for the items. Vendors that are authorized by the source of the item use a tag on the website indicative of such authorization. The tag is preferably included in the title page of the respective website so that when a browser is used to search for the vendors, the resulting listing of respective title pages includes the tag. If a vendor provides several services associated with the item, then several tags may be used for identifying the services.

### RELATED APPLICATIONS

This application claims priority to provisional application Ser. No. 61/001,233 filed on Oct. 31, 2007 and incorporated herein by reference.

### BACKGROUND OF THE INVENTION

1. Field of Invention

This invention pertains to a system for providing websites authorized to market good and services that are easily identifiable when found by a search engine.

2. Background of the Invention

Over the last ten years, the Internet became very popular for various activities, including shopping for goods and services. In some areas, the sales over the Internet exceed by far the sales of similar products via standard venues, such as retail stores and mail order catalogs. Shoppers prefer the Internet for several reasons: it is convenient since it is available at their home or anywhere; it requires no traveling; it is simple and easy; it provides a large number of choices of articles and vendors from literally all over the world.

However some of the very factors that make Internet shopping so convenient are also a source of problems. One disadvantage is that running a simple search for an article on a search engine often results in pages and pages of listings of various vendors. This results in the customer having to spend precious time in determining which vendor to use. Moreover, the listings do not contain any indication of reliability of the vendor, the quality of the products being sold, whether the vendor will stand behind the product, whether the vendor will provide at least some customer support for the product, and so on. Certain articles are often available from many different vendors and if a customer does not recognize the vendors by reputation the customer cannot ascertain the quality of the products offered by the vendor. The very fact that the Internet is so easy to use also allows many parties to offer various goods and services over the Internet that may have poor quality, counterfeit goods or goods and services that may be unacceptable to a buyer. However, once the good or service is bought over the Internet, and delivered, often it is very difficult to obtain a refund, return or otherwise correct its defects.

For these reasons, many customers tend to shy away from Internet transactions. Thus there is a need in commerce and other exchanges of goods and services to provide a means that can be used by a customer to determine which sites are reliable quickly and efficiently.

### SUMMARY OF THE INVENTION

Briefly, the present invention pertains to a system in which several vendors of an item of interest to a user have websites connected to the Internet. Importantly, the vendors that are authorized to distribute the item by the source of the item provide in their website a unique tag. The tag is used to confirm that the corresponding vendor is authorized by the item source. Preferably the tag is a unique image and/or a sequence of alphanumeric characters that is incorporated into the website title page.

A user uses a browser to search for the respective websites. The browser generates and assembles a listing consisting of a plurality of websites associated with the item of interest to the user. The listing consists of a sequence of entries, each entry corresponding to one of the respective websites. More specifically, each entry includes information from the title page of the respective websites.

The title pages of the websites of authorized vendors are designed so that they include said tag. Therefore, the user can look at the listing from the browser and identify very quickly which vendors have been authorized by the item source.

### BRIEF DESCRIPTION OF THE DRAWINGS

FIG. 1 shows the results of a typical prior art search for an article;

FIG. 2 shows the home page or title page configured in accordance with this invention;

FIG. 3 shows a typical code used to generate the page shown on FIG. 2;

FIGS. 4A, 4B and 4C show search results for vendor sites with tags in accordance with this invention;

FIG. 5 shows a flow chart illustrating the operation of a special search engine in accordance with this invention.

### DETAILED DESCRIPTION OF THE INVENTION

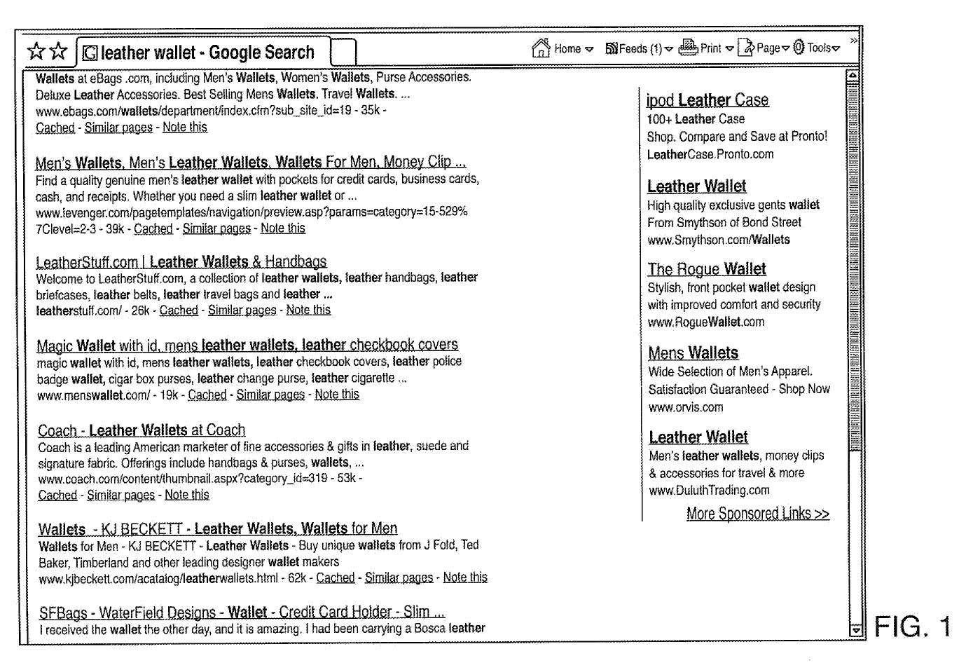

As previously discussed, one problem with existing Internet shopping is that a search for a fairly standard item can return results spanning many pages and covering many different articles and vendors. (In the present application, the term item is used to refer to a product, service or information of interest to users). For example, FIG. 1 shows the results of a standard search for a leather wallet. On FIG. 1 only a small portion of the results are shown with seven general entries on the left. It is interesting to note that these entries are from seven different vendors. Without additional investigation, a customer has no way of knowing who makes the product, whether the vendors are reliable or even legitimate. This is detrimental to both the customer and the vendors of legitimate, high quality products.

In order to solve this problem, in accordance with this invention, the vendors provide on their website, and preferably somewhere on their title page a specific tag which identifies the vendor as a legitimate distributor of the respective product(s). The vendors can be the actual manufacturer of the product. Alternatively, the vendor could be any entity in a legitimate distribution chain to the customer, including an importer, wholesale distributor, retail outlet, etc. In these latter cases, the manufacturer or other entity authorizes the vendor to use the tag on its website.

The tag can consist of one or more elements, including but not limited to unique logos, pictures or other graphic images of various objects, fanciful designs, etc. These symbols may be animated and may include one or more alphanumeric characters. Preferably, a sequence of alphanumeric characters is used as part of the tag. The sequence may include standard alphanumeric characters selected and arranged in an order that has no meaning and is not normally found by a standard search, such as —{S}— —{O}— {$} {||||||} {*5*} <*****>. Of course, as previously mentioned, the tag can also be a non-alphanumeric character, such as a logo or image and can be animated.

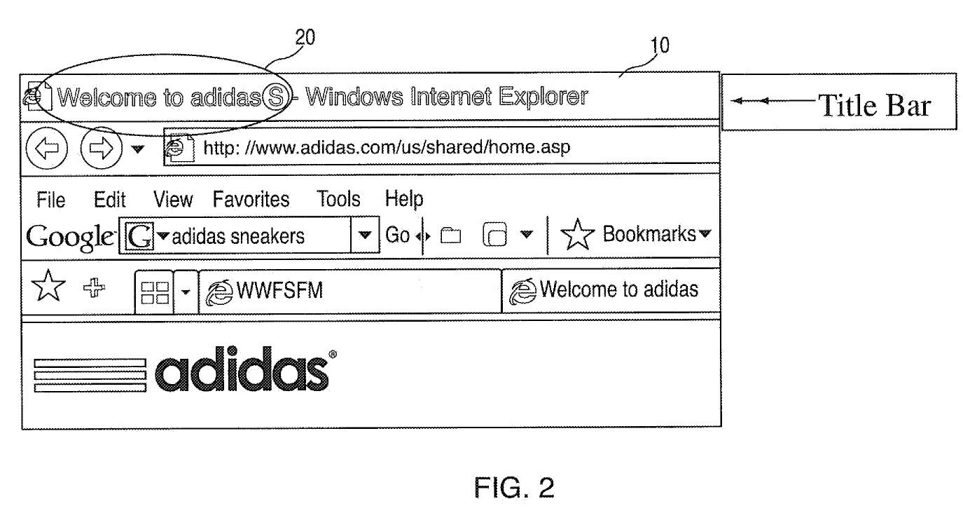

The tag is provided or embedded on the website of the vendor at a location that is known to be searched by search engines. For example, the tag is incorporated into the title bar. FIG. 2 shows a website with a title bar 10 and a tag 20 inserted into the title bar.

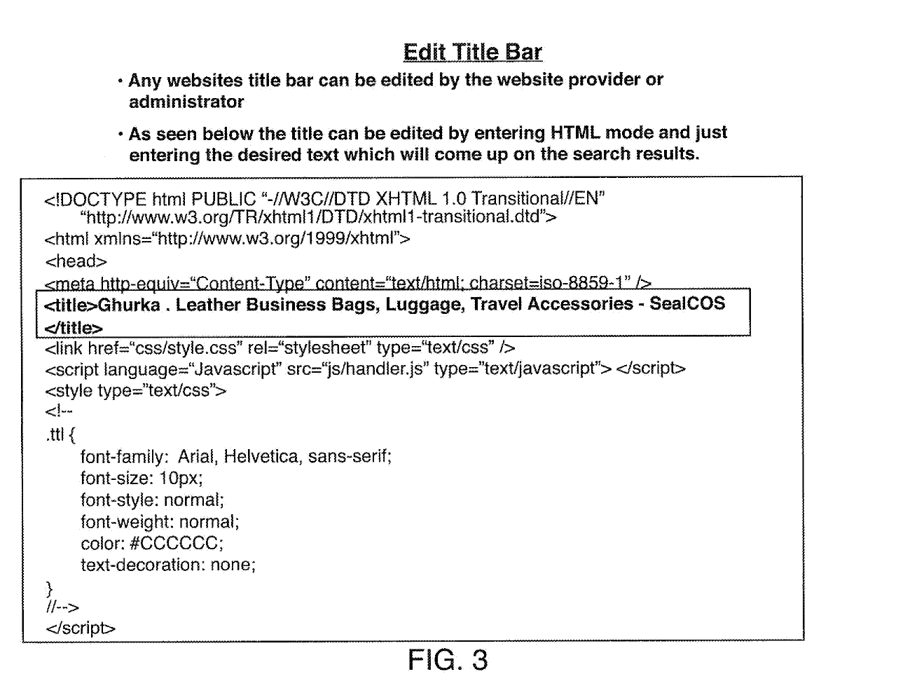

FIG. 3 shows a partial listing of the code used to generate the title bar of FIG. 2. Of course, the title bar can be generated using other means as well, and the code shown in FIG. 3 is presented for illustration purposes only. Moreover, the tag need not be in the title bar.

Once the tag is inserted or imbedded in the web page code, a search engine searching for a particular product/service will find the website and list it together with the tag.

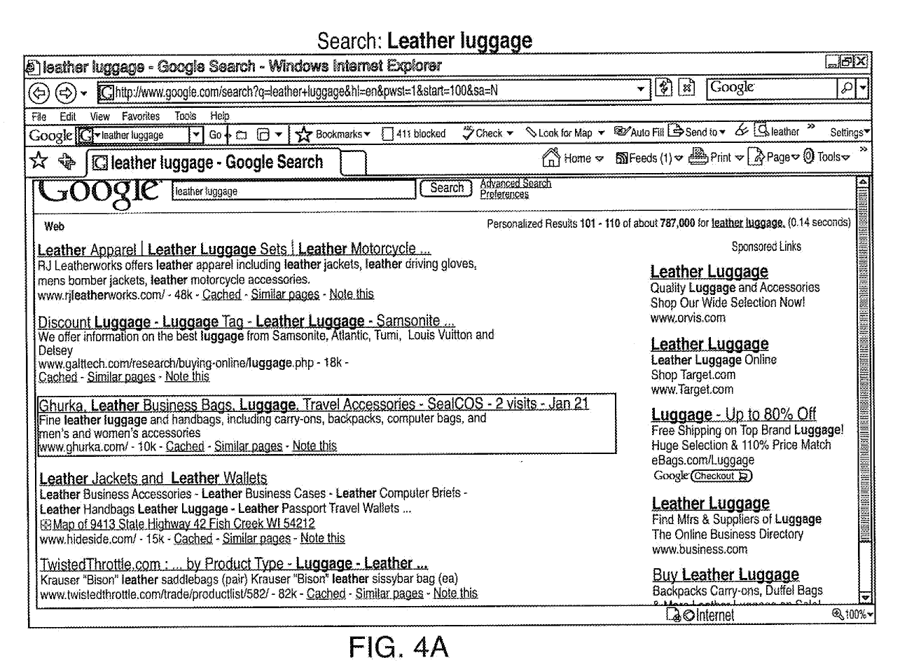

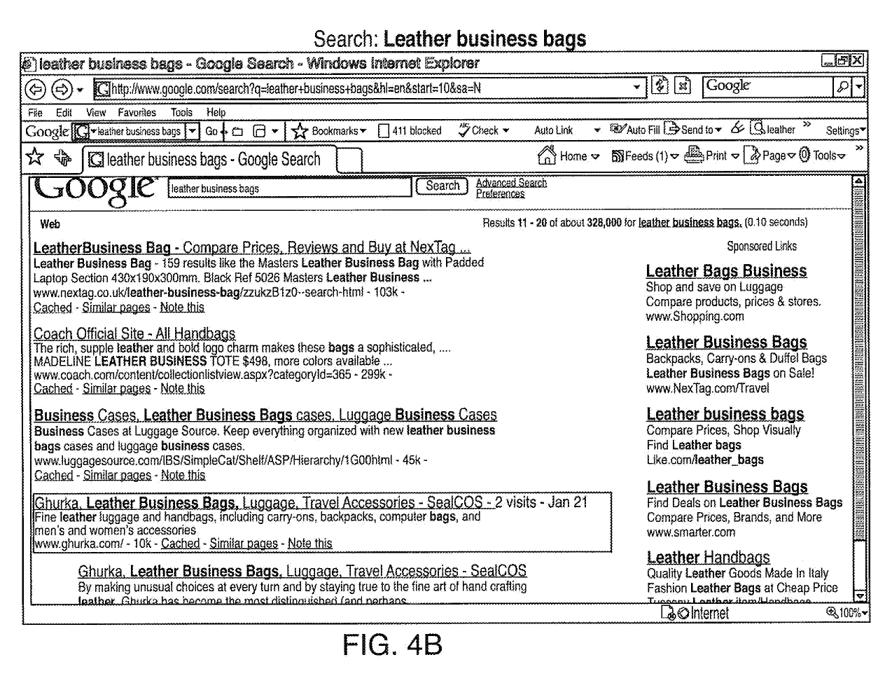

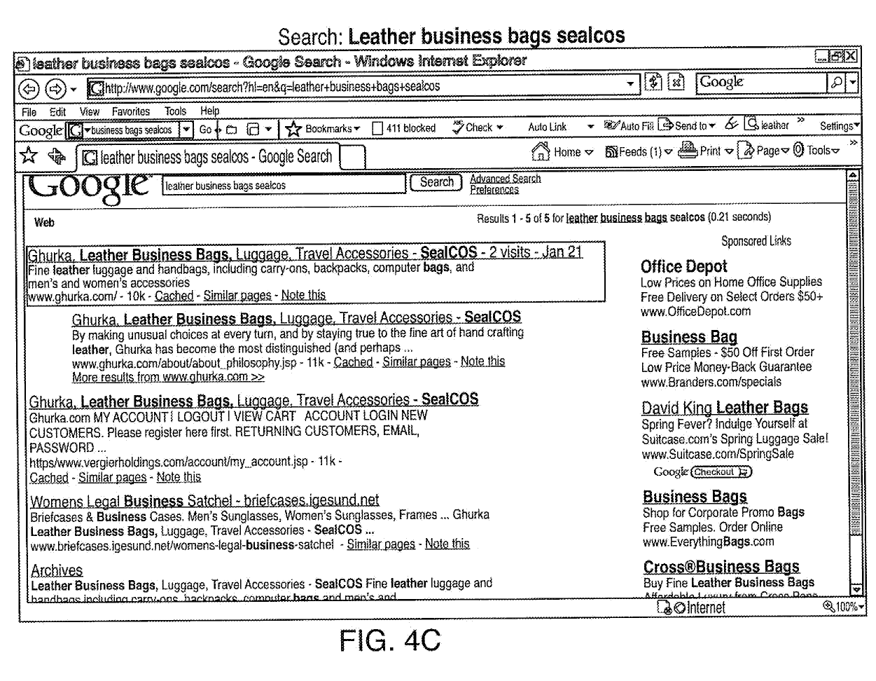

FIGS. 4A, 4B and 4C illustrate how different searches list the website having the title page generated by the code listed on page 3. In this title page, the tag is the alphanumeric tag “SealCOS.”

In FIG. 4A, the search term “Leather luggage” results in a listing with 787,000 entries. Entry number 103 shows the entry with tag SealCOS. The customer running the search will know that among all the other listings, this listing identifies an authorized vendor associated with the respective tag.

FIG. 4B shows the listing for the term “leather business bag.” This listing has 328,000 entries and entry number 14 indicates a vendor associated with the tag SealCOS.

FIG. 4C shows a listing obtained by running a search in which the tag itself is part of the search term (“leather business bags sealcos”). In this case the top three entries identify the respective vendor.

These examples show first that adding a tag on the webpage (especially on the title page) provides a quick and effective means of identifying the vendors associated with the respective tag. The search becomes even more effective if a search engine automatically limits its search to sites including specific authorized tags (such as SealCOS), especially if the tag includes elements other then alphanumeric characters, such as animated images, because such images are difficult to define and insert as a search element.

In the description provided so far, the tag is defined as providing an indication that a particular website is associated with a vendor. However, the tag can be used for other purposes as well. Moreover, different tags may be used for identifying vendors, with some vendors being allowed to use several tags. These concepts are best illustrated with reference to the automotive industry. For example, a first tag may be used to identify the official website of a particular brand of cars, e.g. Lexus®. A second tag can be used to identify dealers selling that particular brand. A third tag can be used to identify entities that are authorized to lease that particular brand. A fourth tag may be used to identify a vendor that provides parts for that brand in the retail market. A fifth tag may be used to identify authorized entities that sell parts for that particular brand. This category may include dealers who sell cars and car parts, as well as independent dealers who only sell specific car components, e.g., tires for that brand. A sixth tag may be used to identify entities that service that brand. A seventh tag may be indentifying a financing company specializing that brand.

Clearly, many vendors can be associated with and use two or more tags associated with the same brand. For example, a dealer may sell the brand, the lease, or sell parts and service for the brand, Moreover, some vendors may be able to use the tags from several different brands. For example, a tire dealer can sell tires for several car brands.

The invention may be implemented using several different techniques. However, a basic premise of the invention is that for all techniques, the vendor first obtains authorization from the proper entity and then the tag is inserted into the website as discussed above. One technique involves merely relying on customers to search the Internet using any standard search engine. The result from such a search consists of many entries, with the entries of authorized vendors having respective tags.

A second technique involves providing or using a search engine that automatically searches only sites with the tags. In one embodiment, the customer provides the acceptable tag(s) and the search engine then either automatically inserts the tag(s) as a search element or otherwise limits its search to websites associated with specific tags.

A third technique involves modifying a search engine so that it searches for and/or lists only websites with any tags. The difference between the second technique and this one is that using the second technique a search engine returns vendors of a particular brand, e.g. all the vendors of FORD cars. Using the third technique, the search engine returns all the vendors for FORD, LINCOLN, CHEVROLET cars etc, as long the websites have the appropriate tags.

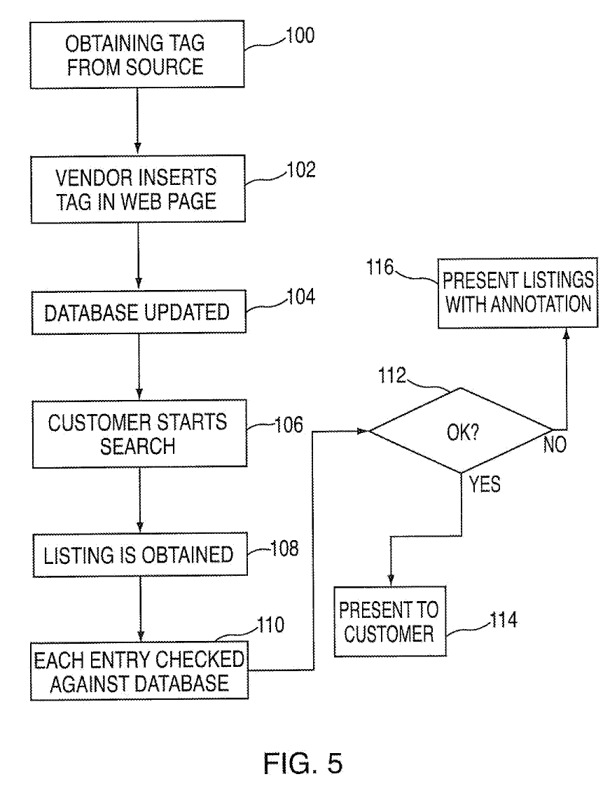

An important feature of the present invention is that a vendor must receives authorization from the proper entity for using the tag. Such authorization may be granted using an appropriate licensing arrangement between the parties that may involve prices, volume, use of trademarks, and so on. However, some vendors may incorporate an unauthorized tag on their website and, unless the manufacturer or other entity controlling the tag use is very diligent, it may not know about such a use. Therefore, a fourth technique may be used to eliminate this problem. This technique is illustrated in FIG. 5 starts in step 100 with the vendor obtaining a tag from a source. In step 102 the vendor inserts the tag in its webpage as discussed above.

In step 104, a database maintained either by the tag source (e.g., the manufacturer or other entity) is updated to indicate that the particular vendor has been granted a tag.

In step 106 a search is started by a potential customer using a modified search engine. In step 108 the search engine obtains a listing of entries, each entry referring to webpage with the respective tag or tags.

In step 110 the search engine (or other software on the customer's device used to perform the search) authenticates whether each entry on the listing is legitimate (e.g., authorized). In step 112 a response is received. If the entries are all authorized, then in step 114 the listing is presented to the customer.

If in step 112 some entries are not authorized then a modified listing is presented in step 116 in which unauthorized entries are deleted or modified to show that that the tag may be problematical.

Obviously numerous modifications may be made to the invention without departing from its scope as defined in the appended claims.

I claim:

1. In a system distributing goods, services and/or information on a distributed computer network, a website comprising at least one page identifying a specific item for distribution to a user and a tag obtained from the source providing the item to indicate that the website is authorized to distribute said item.

2. The website of claim 1 wherein said includes a title page and said tag is incorporated in said title page in a manner that results in the tag being displayed on a listing of results of a search with a web browser for said item.

3. The website of claim 1 wherein said tag is one of an image and an alphanumeric character.

4. The website of claim 2 wherein several different services are associated with said item, and wherein said tag is selected from a group of a plurality of tags, each tag being associated with one of said services.

5. The website of claim 4 wherein said title page includes at least two tags.

6. A computer-implemented method for collecting data about an item from a plurality of websites associated with said item and connected to a distributed computer network, at least one website including a tag indicating that the corresponding website is an authorized website comprising:
using a browser to search said distributed computer network for said websites;
generating a listing of at least some of said websites resulting from the search; and
displaying said listing as a plurality of sequential entries, each entry corresponding to one of said websites, wherein at least one of said entries includes said tag.

7. The method of claim 6 further comprising receiving said tag by a vendor associated with a website from the source of said item.

8. The method of claim 6 wherein said tag is selected from one of an image and an alphanumeric character.

9. The method of claim 6 wherein said tag includes a predetermined sequence of alphanumeric characters.

10. The method of claim 6 wherein each item is associated with a plurality of services, wherein each website is associated with a vendor providing one or more of said services and wherein said website includes several tags, each tag designating one of said services.

11. The method of claim 6 wherein said step of browsing includes using a modified browser adapted to generate only a listing of websites with tags.

12. The method of claim 6 further comprising checking if a website is authorized to have a tag.

13. The method of claim 12 wherein said step of checking includes reviewing if the website is listed on a database.

14. The method of claim 13 wherein said database is stored on a server associated with the source of said item.

15. The method of claim 13 wherein said database is stored on a server independent of the source of said item.
